(19) United States
(12) Patent Application Publication
(10) Pub. No.: US 2026/0080158 A1
(43) Pub. Date: Mar. 19, 2026

(54) TEXT OUTPUT METHOD AND APPARATUS IN DATA ANALYSIS

(71) Applicant: Alipay (Hangzhou) Digital Service Technology Co., Ltd., Hangzhou (CN)

(72) Inventor: Xinxing XU, Hangzhou (CN)

(21) Appl. No.: 19/399,380

(22) Filed: Nov. 24, 2025

Related U.S. Application Data
(63) Continuation-in-part of application No. PCT/CN2024/105270, filed on Jul. 12, 2024.

(30) Foreign Application Priority Data
Jul. 14, 2023 (CN) 202310871216.4

(51) Int. Cl. G06F 40/186; G06F 40/289

(52) U.S. Cl. CPC G06F 40/186; G06F 40/289

(57) ABSTRACT

Implementations of the present specification provide a text output method and apparatus in data analysis. The method includes: determining a metric and an analytic method for a target analysis task, and executing the target analysis task based on the metric and the analytic method, to obtain a data analysis result; extracting a first parameter value of a predetermined feature parameter and a second parameter value of a common parameter from the data analysis result based on parameter configuration information; obtaining an initial text expression template configured for the analytic method; adjusting a content of the initial text expression template based on the first parameter value, to obtain a dedicated text expression template; and filling the dedicated text expression template based on the second parameter value, to obtain a text output result of the data analysis result. As such, adaptability to diversity of analysis scenarios can be implemented, and flexibility and accuracy of text output can be ensured.

The present application is a continuation application of PCT Application No. PCT/CN2024/105270, filed on Jul. 12, 2024, which claims priority to Chinese Patent Application No. 2023108712164, filed with the China National Intellectual Property Administration on Jul. 14, 2023, and entitled “TEXT OUTPUT METHOD AND APPARATUS IN DATA ANALYSIS”, which are each incorporated herein by reference in their entirety.

### TECHNICAL FIELD

One or more implementations of the present specification relate to the computer field, and in particular, to a text output method and apparatus in data analysis.

### BACKGROUND

In the data analysis field, data analysis results are often output to users in an expression manner of graphs. This expression manner needs to occupy a large amount of screen space, is not easy for the users to understand, and is not as concise and efficient as a natural language expression manner. For example, in a multi-dimensional analysis scenario, indicator data in a plurality of dimensions is displayed by using a graph, and the user needs to understand the graph, analyze and compare the indicator data in the plurality of dimensions, and then summarize data features. However, in the natural language expression manner, data features can be directly provided, thereby lowering costs of understanding by the user. Data analysis can be statistical analysis performed on privacy data, and the privacy data needs to be protected from disclosure.

### SUMMARY

One or more implementations of the present specification describe a text output method and apparatus in data analysis, which can adapt to diversity of analysis scenarios and improve flexibility and accuracy of text output.

According to a first aspect, a text output method in data analysis is provided. The method includes: determining a metric and an analytic method for a target analysis task, and executing the target analysis task based on the metric and the analytic method, to obtain a data analysis result; extracting a first parameter value of a predetermined feature parameter and a second parameter value of a common parameter from the data analysis result based on parameter configuration information; obtaining an initial text expression template configured for the analytic method; adjusting a content of the initial text expression template based on the first parameter value, to obtain a dedicated text expression template; and filling the dedicated text expression template based on the second parameter value, to obtain a text output result of the data analysis result.

In a possible implementation, the determining the metric and the analytic method for the target analysis task includes: receiving an instruction that triggers the target analysis task, the instruction including a metric identifier and a method identifier; and determining a metric identified by the metric identifier as the metric for the target analysis task, and determining an analytic method identified by the method identifier as the analytic method for the target analysis task.

In a possible implementation, the determining the metric and the analytic method for the target analysis task includes: receiving an instruction that triggers the target analysis task, the instruction including a metric identifier and an analysis objective; and determining a metric identified by the metric identifier as the metric for the target analysis task, and determining an analytic method corresponding to the analysis objective as the analytic method for the target analysis task based on the analysis objective and a predetermined correspondence between an analysis objective and an analytic method.

In a possible implementation, the initial text expression template is configured as a first structure; and the first structure includes a to-be-filled content identifier corresponding to the common parameter and a to-be-adjusted content identifier corresponding to the feature parameter.

In a possible implementation, the initial text expression template includes at least one preconfigured narrative structure, the narrative structure includes at least one preconfigured paragraph, the preconfigured paragraph includes at least one preconfigured sentence, and the preconfigured sentence includes at least one preconfigured phrase.

Further, the first parameter value of the feature parameter is used to identify whether a first service phenomenon occurs; and the adjusting the content of the initial text expression template includes: determining whether the first parameter value falls within a predetermined first value range, the first value range identifying that the first service phenomenon does not occur; and in response to determining that the first parameter value falls within the predetermined first value range, deleting a first narrative structure used to describe the first service phenomenon in the initial text expression template or deleting a first paragraph in the first narrative structure.

Further, the first service phenomenon is a data abnormality state.

Further, the first parameter value of the feature parameter is used to identify a target analysis result among a first analysis result or a second analysis result that possibly occurs; and the adjusting the content of the initial text expression template includes: determining whether the first parameter value falls within a predetermined second value range, the second value range identifying that the target analysis result is the first analysis result; and in response to determining that the first parameter value falls within the predetermined second value range, determining that a first phrase in the initial text expression template includes a first optional word, the first optional word being used to describe the first analysis result; or in response to determining that the first parameter value does not fall within the predetermined second value range, determining that a first phrase in the initial text expression template includes a second optional word, the second optional word being used to describe the second analysis result.

Further, the first analysis result is an increase in a metric value from a previous metric value, the second analysis result is a decrease in the metric value from the previous value, the first optional word is highest, and the second optional word is lowest.

Further, the initial text expression template includes a first initial sub-template and a plurality of second initial sub-templates that are subsequent to the first initial sub-template; and the adjusting the content of the initial text expression template includes: adjusting a content of the first initial sub-template based on the first parameter value, to obtain a first dedicated sub-template; selecting a to-be-adjusted second initial sub-template from the plurality of second initial sub-templates based on the first dedicated sub-template; and adjusting a content of the selected second initial sub-template to obtain a second dedicated sub-template, the first dedicated sub-template and the second dedicated sub-template forming the dedicated text expression template.

In a possible implementation, the filling the dedicated text expression template includes: searching the dedicated text expression template for a location of a parameter identifier corresponding to the second parameter value; and filling the second parameter value into the location of the parameter identifier in the dedicated text expression template, to obtain the text output result of the data analysis result.

According to a second aspect, a text output apparatus in data analysis is provided. The apparatus includes: an execution unit, configured to: determine a metric and an analytic method for a target analysis task, and execute the target analysis task based on the metric and the analytic method, to obtain a data analysis result; an extraction unit, configured to extract, based on parameter configuration information, a first parameter value of a predetermined feature parameter and a second parameter value of a common parameter from the data analysis result obtained by the execution unit; an acquisition unit, configured to obtain an initial text expression template configured for the analytic method determined by the execution unit; an adjustment unit, configured to adjust, based on the first parameter value extracted by the extraction unit, a content of the initial text expression template obtained by the acquisition unit, to obtain a dedicated text expression template; and a filling unit, configured to fill, based on the second parameter value extracted by the extraction unit, the dedicated text expression template obtained by the adjustment unit, to obtain a text output result of the data analysis result obtained by the execution unit.

According to a third aspect, a computer-readable storage medium is provided. The computer-readable storage medium stores a computer program, and when the computer program is executed on a computer, the computer is enabled to perform the method according to the first aspect.

According to a fourth aspect, a computing device is provided, including a memory and a processor. The memory stores executable code, and when the processor executes the executable code, the method according to the first aspect is implemented.

According to the method and the apparatus provided in the implementations of the present specification, first, a metric and an analytic method for a target analysis task are determined, and the target analysis task is executed based on the metric and the analytic method, to obtain a data analysis result; then, a first parameter value of a predetermined feature parameter and a second parameter value of a common parameter are extracted from the data analysis result based on parameter configuration information; then, an initial text expression template configured for the analytic method is obtained; then, a content of the initial text expression template is adjusted based on the first parameter value, to obtain a dedicated text expression template; and the dedicated text expression template is filled based on the second parameter value, to obtain a text output result of the data analysis result. It can be learned from the above that in the implementations of the present specification, the initial text expression template is configured for the analytic method. The initial text expression template can reflect a characteristic of the analytic method, and the initial text expression template is not fixed, and can be adjusted based on the parameter value of the feature parameter in the data analysis result, to obtain the dedicated text expression template. Then, the dedicated text expression template is filled based on the parameter value of the common parameter in the data analysis result, to obtain the text output result. The parameter value of the feature parameter reflects a characteristic of an analysis scenario. As such, adaptability to diversity of analysis scenarios can be implemented, and flexibility and accuracy of text output can be ensured.

### BRIEF DESCRIPTION OF DRAWINGS

To describe the technical solutions in the implementations of the present specification more clearly, the following briefly describes the accompanying drawings needed for describing the implementations. Clearly, the accompanying drawings in the following description show merely some implementations of the present specification, and a person of ordinary skill in the art can still derive other drawings from these accompanying drawings without making innovative efforts.

FIG. 1 is a schematic diagram illustrating some implementations scenario of some implementations according to the present specification;

FIG. 2 is a flowchart illustrating a text output method in data analysis according to some implementations;

FIG. 3 is a schematic diagram illustrating an online processing process in data analysis according to some implementations;

FIG. 4 is a schematic diagram illustrating a processing process for an initial text expression template according to some implementations; and

FIG. 5 is a schematic block diagram illustrating a text output apparatus in data analysis according to some implementations.

### DESCRIPTION OF IMPLEMENTATIONS

The following describes, with reference to the accompanying drawings, the solutions provided in the present specification.

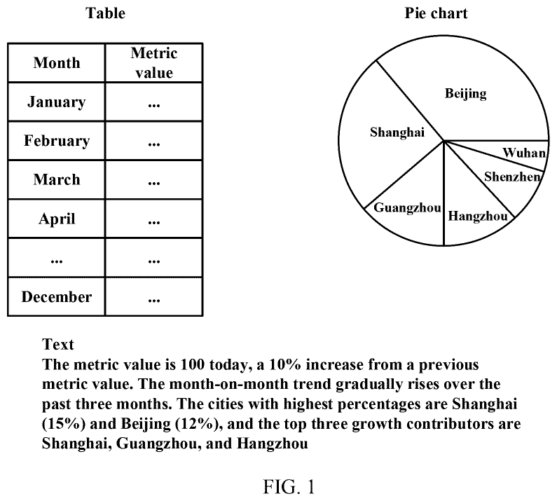

FIG. 1 is a schematic diagram illustrating some implementations scenario of some implementations according to the present specification. Some implementations scenario involves text output in data analysis. It can be understood that the text output means to output a data analysis result in a natural language expression manner. In data analysis, appropriate statistical analytic methods are used to analyze, summarize, understand, and digest large amounts of collected data, to maximize development of functions of the data and play the role of the data. Data analysis is a process of studying and summarizing data in detail to extract useful information and draw conclusions.

Referring to FIG. 1, in the data analysis field, data analysis results are often output to users in an expression manner of graphs. For example, a table displays a metric value of a certain metric for each month, and a pie chart displays a percentage of a metric value of a certain metric for each city. This expression manner may occupy a large amount of screen space, is not easy for the users to understand, and cannot directly provide data features. However, a text like “The metric value is 100 today, a 10% increase from a previous metric value. The month-on-month trend gradually rises over the past three months. The cities with highest percentages are Shanghai (15%) and Beijing (12%), and the top three growth contributors are Shanghai, Guangzhou, and Hangzhou” can directly provide data features, which make it easier for a user to understand.

Data analysis faces various analysis scenarios. For example, a metric for an analysis task can be a sales volume or a fund gain of a company, an analytic method for the analysis task can be month-on-month comparison or year-on-year comparison, and a data analysis result can be a month-on-month increase, a month-on-month decrease, a year-on-year increase, or a year-on-year decrease.

In implementations of the present specification, a text expression template is preconfigured, and then the text expression template is filled based on a data analysis result, to obtain a text output result of the data analysis result. An initial text expression template is preconfigured for an analytic method. Subsequently, the initial text expression template is adjusted based on a data analysis result, to obtain a dedicated text expression template. Then, the dedicated text expression template is filled to obtain a text output result. As such, adaptability to diversity of analysis scenarios can be implemented.

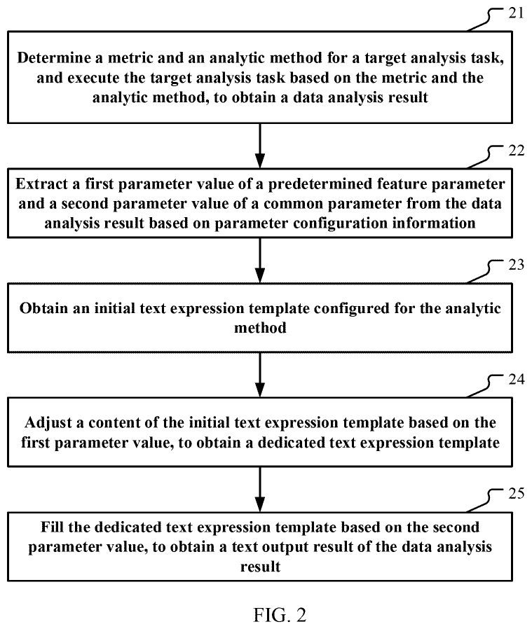

FIG. 2 is a flowchart illustrating a text output method in data analysis according to some implementations. The method can be based on the implementation scenario shown in FIG. 1. As shown in FIG. 2, the text output method in data analysis in some implementations includes the following steps: Step 21: Determine a metric and an analytic method for a target analysis task, and execute the target analysis task based on the metric and the analytic method, to obtain a data analysis result. Step 22: Extract a first parameter value of a predetermined feature parameter and a second parameter value of a common parameter from the data analysis result based on parameter configuration information. Step 23: Obtain an initial text expression template configured for the analytic method. Step 24: Adjust a content of the initial text expression template based on the first parameter value, to obtain a dedicated text expression template. Step 25: Fill the dedicated text expression template based on the second parameter value, to obtain a text output result of the data analysis result. The following describes specific manners of performing the above steps.

First, in step 21, the metric and the analytic method for the target analysis task are determined, and the target analysis task is executed based on the metric and the analytic method, to obtain the data analysis result. It can be understood that data analysis is analysis performed on a large amount of data, and to-be-analyzed data can be correspondingly determined when the metric for the target analysis task is determined. The analytic method reflects how to analyze data, and is used to determine a parameter included in the data analysis result.

In implementations of the present specification, the metric and the analytic method can be directly set by a user. Alternatively or additionally, one or more of the metric or analytic method can be determined automatically by a machine, e.g., an artificial intelligence unit. In some implementations, a user first sets the metric and an analysis objective, and then a computer determines an analytic method corresponding to the analysis objective. For example, the analysis objective of the user can include a plurality of objectives such as a recent change of a certain metric, a long-term trend, a percentage of each dimension, and fluctuation analysis. If a graphical means such as a report is used, an indicator card, a pie chart, a line chart, fluctuation analysis, and other components need to be set. In this case, a large amount of screen space is occupied, and it is not easy to summarize data features. However, data features can be directly provided by using a text expression means.

In an example, the determining the metric and the analytic method for the target analysis task includes: receiving an instruction that triggers the target analysis task, the instruction including a metric identifier and a method identifier; and determining a metric identified by the metric identifier as the metric for the target analysis task, and determining an analytic method identified by the method identifier as the analytic method for the target analysis task.

In an example, the user directly sets the metric and the analytic method, and the analytic method can be accurately determined.

In an example, the determining the metric and the analytic method for the target analysis task includes: receiving an instruction that triggers the target analysis task, the instruction including a metric identifier and an analysis objective; and determining a metric identified by the metric identifier as the metric for the target analysis task, and determining an analytic method corresponding to the analysis objective as the analytic method for the target analysis task based on the analysis objective and a predetermined correspondence between an analysis objective and an analytic method.

In this example, the user first sets the metric and the analysis objective, and then the computer determines the analytic method corresponding to the analysis objective. The analysis objective is a textual expression used for ease of understanding by the user, and the analytic method is a formulaic abstract expression. The analysis objective is set by the user to facilitate understanding and operation by the user.

Then, in step 22, the first parameter value of the predetermined feature parameter and the second parameter value of the common parameter are extracted from the data analysis result based on the parameter configuration information. It can be understood that the parameter configuration information records which parameters are feature parameters and which parameters are common parameters.

In some implementations of the present specification, the feature parameter and the common parameter are predetermined, and the first parameter value and the second parameter value are extracted from the data analysis result, that is, the first parameter value and the second parameter value are learned of after the data analysis. The first parameter value of the feature parameter can be used to indicate a purpose of the analytic method, a meaning or a characteristic of a predetermined indicator, etc. The second parameter value of the common parameter can be an indicator value of the predetermined indicator, etc.

Then, in step 23, the initial text expression template configured for the analytic method is obtained. It can be understood that there are usually a plurality of types of analytic methods, and an initial text expression template can be separately configured for each type of analytic method.

In an example, the initial text expression template is configured as a first structure; and the first structure includes a to-be-filled content identifier corresponding to the common parameter and a to-be-adjusted content identifier corresponding to the feature parameter.

For example, the initial text expression template configured for the analytic method is “month-on-month A (increase/decrease) B”. Herein, A represents the feature parameter, A (increase/decrease) represents the to-be-adjusted content, and B represents the common parameter, and also represents the to-be-filled content.

In an example, the initial text expression template includes at least one preconfigured narrative structure, the narrative structure includes at least one preconfigured paragraph, the preconfigured paragraph includes at least one preconfigured sentence, and the preconfigured sentence includes at least one preconfigured phrase.

In some implementations of the present specification, the text output result can be considered as a narrative, and construction of the narrative can follow the following strategies:

Strategy 1: A main structure of a narrative is first established, and then a content in the structure is filled.

A narrative first has a main structure, for example, a “general-specific” structure or a “general-specific-general” structure. Each structure includes a specific narrative content. For example, in the “general-specific-general” structure, a current data situation is first summarized, a current data phenomenon and impact are described in various dimensions in a middle part, and finally a problem caused and a future plan are summarized. The main structure of the narrative can be determined based on a theme or an application scenario of the narrative. A “general” or “specific” structure is referred to as a narrative structure or section. One narrative can include one or more narrative structures, and this relationship can be expressed as narrative -* section.

Strategy 2: One paragraph includes complete analysis and descriptions of one service phenomenon, and whether the paragraph should exist is determined based on a data analysis result.

After a narrative structure has been determined, a paragraph configured for each narrative structure does not necessarily exist. For example, in a “general-specific-specific-general” structure, when second “specific” is intended to describe data in an abnormal state in dimensions, if there is no abnormal data, there is no paragraph in the narrative structure. Therefore, the “general-specific-specific-general” structure is displayed as a “general-specific-general” structure. Similarly, in a narrative structure, there are three paragraphs, and the three paragraphs respectively describe year-on-year/month-on-month performance, a trend, and anomaly analysis of a metric. If a data analysis result indicates no anomaly, that is, if it is determined that there is a normal situation, no description of a paragraph corresponding to the anomaly analysis needs to be output. One paragraph can include a plurality of sentences, and the plurality of sentences jointly form contents that need to be described in the paragraph. The sentence can include a data feature, an analysis conclusion, a service phrase, or an objective phenomenon. Whether a paragraph in a narrative is displayed is determined based on whether a content or a phenomena described in the paragraph occurs. A paragraph in a structure can be defined as a topic structure (topic). One narrative structure can include one or more topics, and this relationship can be expressed as section -* topic. One paragraph can include a plurality of sentences. One sentence structure includes one or more conclusions, pieces of data, or user descriptions. A structure that outputs such a sentence can be defined as an analytic method (analytic), and a relationship between the topic structure and the analytic method can be expressed as topic -* analytic.

Strategy 3: One sentence can include one or more analysis conclusions, and whether the sentence should exist is determined based on whether the conclusion is meaningful.

One sentence usually includes a plurality of analysis conclusions or query results, and each analysis conclusion and query result can be considered as one independent data query or one call to a data analysis interface. Therefore, one analytic method can correspond to one existing insight service, for example, year-on-year/month-on-month performance or fluctuation analysis. In some implementations of the present specification, a function of the analytic method is essentially to take out a part, in a sentence, that needs to be calculated, so as to subsequently logically generate a text. In a description phase, a conclusion provided in an analysis result can be meaningless. In this case, the conclusion may not be described. Therefore, whether a content in a sentence needs to be presented is determined based on a result of an analytic method that generates this sentence. A structure of a text or a phrase is defined as a phrase (phrase). One sentence can include a plurality of phrases, and this relationship can be expressed as analytic *- phrase.

Strategy 4: One analytic method can correspond to a plurality of paragraphs.

Most analytic methods such as year-on-year/month-on-month performance and a trend can be described by using one sentence. However, in a scenario such as fluctuation analysis, one or more paragraphs are often required to describe a possible analysis conclusion. There is no strong correspondence between a paragraph and the analytic method herein. Therefore, the analytic method can include a description form of a plurality of paragraphs. A paragraph in a description phase is defined as paragraph, and a relationship between the analytic method, the paragraph, and the phrase can be expressed as analytic -* paragraph -* phrase.

Strategy 5: The analytic method determines not only a query behavior of the method but also a description manner of the method.

An analytic method can be essentially abstracted to obtain a result from a data set by using a set of logic. A meaning of the result, whether the result is meaningful, and how to provide descriptions can be determined based on the method. In principle, analytic methods are independent of each other.

Strategy 6: A display form of the analytic method is determined based on a data structure.

Data output by an analytic method may have two structures: Map or List<Map>. Usually, Map is a flat structure and is presented by using a short sentence, while a structure of List<Map> can be presented by using a list or a separator. Each word in a sentence can be an independent phrase (phrase). Therefore, a display behavior for an internal structure of the phrase can be defined. For example, scenarios such as value highlighting, trend chart details for describing a trend, and text interaction for association with another paragraph can all be carried in this structure.

Strategy 7: Entities independently determine description manners of the entities.

The entities are backend entities, that is, three entity objects: a narrative (narrative), a topic structure (topic), and an analytic method (analytic). A relationship between the three entities is a one-to-many relationship. Descriptions of analytic methods can be connected with conjunctions, but no logical association is described. A query association is determined based on a connection of a query plan.

Then, in step 24, the content of the initial text expression template is adjusted based on the first parameter value, to obtain the dedicated text expression template. It can be understood that the adjustment can include adjustment in two aspects: adjustment of a structure of the template and adjustment of a phrase in the template.

In an example, the first parameter value of the feature parameter is used to identify whether a first service phenomenon occurs; and the adjusting the content of the initial text expression template includes: determining whether the first parameter value falls within a predetermined first value range, the first value range identifying that the first service phenomenon does not occur; and when it is determined that the first parameter value falls within the predetermined first value range, deleting a first narrative structure used to describe the first service phenomenon in the initial text expression template or deleting a first paragraph in the first narrative structure.

Further, the first service phenomenon is a data abnormality state.

In this example, for a possible service phenomenon, a narrative structure or a paragraph used to describe the service phenomenon is preconfigured in the initial text expression template. Subsequently, it can be determined, based on the parameter value of the feature parameter, whether the service phenomenon occurs, and when it is determined that the service phenomenon does not occur, a structure of the template is flexibly adjusted, so that the template is more applicable to a specific analysis scenario.

In an example, the first parameter value of the feature parameter is used to identify a target analysis result among a first analysis result or a second analysis result that possibly occurs; and the adjusting the content of the initial text expression template includes: determining whether the first parameter value falls within a predetermined second value range, the second value range identifying that the target analysis result is the first analysis result; and when it is determined that the first parameter value falls within the predetermined second value range, determining that a first phrase in the initial text expression template includes a first optional word, the first optional word being used to describe the first analysis result; or when it is determined that the first parameter value does not fall within the predetermined second value range, determining that a first phrase in the initial text expression template includes a second optional word, the second optional word being used to describe the second analysis result.

Further, the first analysis result is an increase in a metric value from a previous metric value, the second analysis result is a decrease in the metric value from the previous metric value, the first optional word is highest, and the second optional word is lowest.

In this example, for two analysis results that possibly occur, optional words used to describe the two analysis results are preconfigured in the initial text expression template. Subsequently, an analysis result that occurs can be determined based on the parameter value of the feature parameter, and after the analysis result that occurs is determined, a phrase in the template is flexibly adjusted, so that the template is more applicable to a specific analysis scenario.

In an example, the initial text expression template includes a first initial sub-template and a plurality of second initial sub-templates that are subsequent to the first initial sub-template; and the adjusting the content of the initial text expression template includes: adjusting a content of the first initial sub-template based on the first parameter value, to obtain a first dedicated sub-template; selecting a to-be-adjusted second initial sub-template from the plurality of second initial sub-templates based on the first dedicated sub-template; and adjusting a content of the selected second initial sub-template to obtain a second dedicated sub-template, the first dedicated sub-template and the second dedicated sub-template forming the dedicated text expression template.

In an example, a plurality of sub-templates are set in the initial text expression template, and there is an association relationship between the sub-templates that are in a sequence. The parameter value of the feature parameter is configured to affect one or more of a content of a sub-template or a selection of a sub-template. For example, the parameter value of the feature parameter not only affects a content of a sub-template with a higher ranking, but also affects selection of a sub-template with a lower ranking. Therefore, flexible combination of the sub-templates is more facilitated, and reusability of the sub-template is improved, so that the template is more applicable to a specific analysis scenario.

Finally, in step 25, the dedicated text expression template is filled based on the second parameter value, to obtain the text output result of the data analysis result. It can be understood that the text output result usually includes some specific data analysis results, for example, a 10% month-on-month increase. Herein, 10% is a content that needs to be filled.

In an example, the filling the dedicated text expression template includes: searching the dedicated text expression template for a location of a parameter identifier corresponding to the second parameter value; and filling the second parameter value into the location of the parameter identifier in the dedicated text expression template, to obtain the text output result of the data analysis result.

In some implementations of the present specification, the following logic can be followed in implementation: An analytic method (analytic) generates a variable (variable), and the variable (variable) forms a data pool. The data pool includes a data analysis result of the analytic method, including data or a conclusion. A description form is determined based on a structure (structure), including a structure (phrase, paragraph, or bullet) used, an organization manner (content template) used, and a correspondence with data (variable_id). Text data is described by using a variable (variable)+a structure (structure). Both the variable and the structure can be used to determine whether to display data. A display feature and a content are determined based on the variable, and a display structure and a sequence are determined based on the structure. Natural-language generation (NLG) objects at all levels complete text generation by using the structure. One topic structure (topic) includes a plurality of analytic methods (analytic). The analytic method (analytic) describes a group of associable or mergeable queries, serving as a data query service call. The analytic methods (analytic) are executed in parallel to summarize result data at a topic structure (topic) level, and a narrative structure (section) is generated by using a structure (structure) of the topic structure (topic). One narrative (narrative) includes a plurality of topic structures (topic). One topic structure (topic) includes associable or mergeable service descriptions, serving as an abstraction of a text structure. The topic structures (topic) are executed in parallel to summarize results at a narrative (narrative) level, and a schema (schema) of the narrative is generated by using a structure (structure) of the narrative (narrative).

FIG. 3 is a schematic diagram illustrating an online processing process in data analysis according to some implementations. Referring to FIG. 3, a user first separately sets a metric and an analytic method for a current analysis task, and then a computer performs analysis to obtain a parameter value of a feature parameter and a parameter value of a common parameter. Then, a dedicated text expression template is determined based on the parameter value of the feature parameter and the analytic method, and the dedicated text expression template is filled based on the parameter value of the common parameter, to obtain a text output result. It can be understood that the dedicated text expression template is obtained after an initial text expression template is adjusted. The initial text expression template is preconfigured for the analytic method, and a content of the initial text expression template is adjusted based on the parameter value of the feature parameter, to obtain the dedicated text expression template.

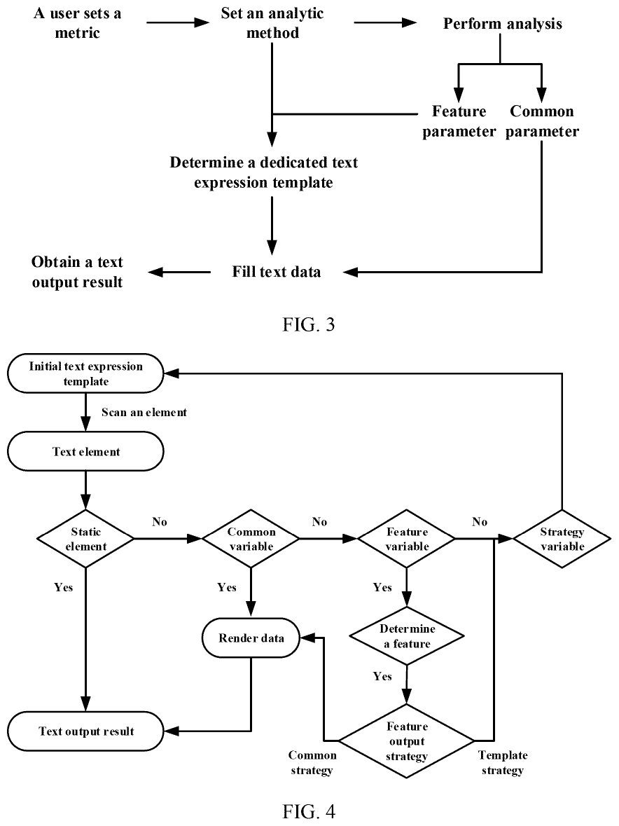

FIG. 4 is a schematic diagram illustrating a processing process for an initial text expression template according to some implementations. Referring to FIG. 4, the initial text expression template includes several elements. After a current initial text expression template configured for an analytic method is obtained, elements included in the initial text expression template can be scanned, and a text element in the initial text expression template can be extracted. For the text element, it can be determined whether the text element is a static element. It can be understood that the static element can be considered as a constant. If it is determined that the text element is a static element, the text element is directly output as a part of a text output result. If it is determined that the text element is not a static element, it is further determined whether the text element is a common variable. It can be understood that the common variable is the above common parameter. If it is determined that the text element is a common variable, a value of the common variable is used as a part of a text output result after data rendering. If it is determined that the text element is not a common variable, it is further determined whether the text element is a feature variable. It can be understood that the feature variable is the above feature parameter. If it is determined that the text element is a feature variable, a hit feature is further determined based on a value of the feature variable. For example, if the value is greater than 10, “significant increase” is hit, and if the value is less than 0, abnormal decrease” is hit. Then, a corresponding feature output strategy is selected based on the hit feature, and it is determined whether the feature output strategy is a common strategy or a template strategy. When it is determined that the strategy is a common strategy, an output content corresponding to the feature output strategy is used as a part of a text data result after data rendering. When it is determined that the strategy is a template strategy, an output content corresponding to the feature output strategy is used as a value of a strategy variable. The value of the strategy variable is used to determine a next initial text expression template. In addition, if it is determined that the text element is not a feature variable, it is considered, by default, that the text element is a strategy variable, and the text element is used as a value of the strategy variable.

It can be understood that the processing process shown in FIG. 4, the process of adjusting the initial text expression template to obtain the dedicated text expression template, and the process of filling the dedicated text expression template are synchronously performed. In some implementations, the two processes can be sequentially performed. For example, the initial text expression template is first adjusted to obtain the dedicated text expression template, and then the dedicated text expression template is filled to obtain the text output result.

In some implementations of the present specification, there can be one or more metrics for one analysis task, and there can be one or more analytic methods for one analysis task. When there are a plurality of analytic methods, an initial text expression template corresponding to each analytic method can be configured. One initial text expression template or a plurality of initial text expression templates can be configured for one analytic method. One initial text expression template can include a plurality of initial text expression sub-templates. One or more feature parameters can be involved in one analytic method, and one or more common parameters can be involved in one analytic method. It can be understood that when the analysis task corresponds to a plurality of initial text expression templates, processing manners for all the initial text expression templates are similar. Details are omitted herein for simplicity.

In some implementations of the present specification, construction of the text output result mainly includes the following core steps. First, an initial text expression template needs to be preconfigured, that is, an output structure needs to be designed. For example, the initial text expression template is “${metric_name} is ${metric_value}”, where metric_name represents a variable name, and metric_value represents a variable value. Then, after a data analysis result is obtained by executing a data analysis task, a variable structure (AbstractVariable) is constructed from the data analysis result, for example, the variable structure is {“metric_name”: “unit price”, “metric_value”: 2}. Then, a structured text content is generated by using the variable structure and the initial text expression template, and the obtained structured text content is “unit price is 2”. Finally, a text structure is generated by using a structural characteristic, for example, the generated text structure is a phrase {“phrase”: [{“value”: “unit price”}, {“value”: “is”, {“value”: 2}]}.

According to the method provided in some implementations of the present specification, first, a metric and an analytic method for a target analysis task are determined, and the target analysis task is executed based on the metric and the analytic method, to obtain a data analysis result; then, a first parameter value of a predetermined feature parameter and a second parameter value of a common parameter are extracted from the data analysis result based on parameter configuration information; then, an initial text expression template configured for the analytic method is obtained; then, a content of the initial text expression template is adjusted based on the first parameter value, to obtain a dedicated text expression template; and the dedicated text expression template is filled based on the second parameter value, to obtain a text output result of the data analysis result. It can be learned from the above that in some implementations of the present specification, the initial text expression template is configured for the analytic method. The initial text expression template can reflect a characteristic of the analytic method, and the initial text expression template is not fixed, and can be adjusted based on the parameter value of the feature parameter in the data analysis result, to obtain the dedicated text expression template. Then, the dedicated text expression template is filled based on the parameter value of the common parameter in the data analysis result, to obtain the text output result. The parameter value of the feature parameter reflects a characteristic of an analysis scenario. As such, adaptability to diversity of analysis scenarios can be implemented, and flexibility and accuracy of text output can be ensured.

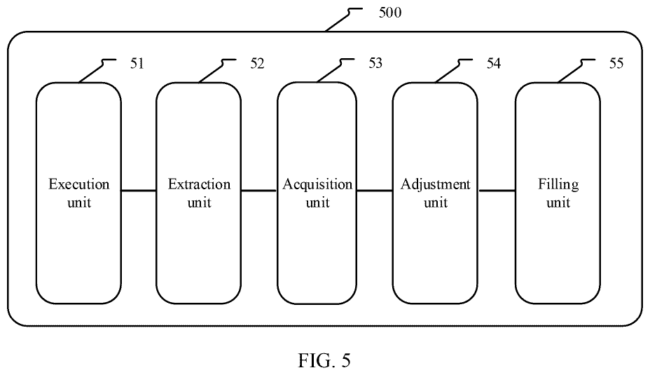

According to some implementations of another aspect, a text output apparatus in data analysis is further provided. The apparatus is configured to perform the method provided in the implementations of the present specification. FIG. 5 is a schematic block diagram illustrating a text output apparatus in data analysis according to some implementations. As shown in FIG. 5, the apparatus 500 includes: an execution unit 51, configured to: determine a metric and an analytic method for a target analysis task, and execute the target analysis task based on the metric and the analytic method, to obtain a data analysis result; an extraction unit 52, configured to extract, based on parameter configuration information, a first parameter value of a predetermined feature parameter and a second parameter value of a common parameter from the data analysis result obtained by the execution unit 51; an acquisition unit 53, configured to obtain an initial text expression template configured for the analytic method determined by the execution unit 51; an adjustment unit 54, configured to adjust, based on the first parameter value extracted by the extraction unit 52, a content of the initial text expression template obtained by the acquisition unit 53, to obtain a dedicated text expression template; and a filling unit 55, configured to fill, based on the second parameter value extracted by the extraction unit 52, the dedicated text expression template obtained by the adjustment unit 54, to obtain a text output result of the data analysis result obtained by the execution unit 51.

In some implementations, the execution unit 51 includes: a first receiving subunit, configured to receive an instruction that triggers the target analysis task, the instruction including a metric identifier and a method identifier; and a first determining subunit, configured to: determine a metric identified by the metric identifier obtained by the first receiving subunit as the metric for the target analysis task, and determine an analytic method identified by the method identifier obtained by the first receiving subunit as the analytic method for the target analysis task.

In some implementations, the execution unit 51 includes: a second receiving subunit, configured to receive an instruction that triggers the target analysis task, the instruction including a metric identifier and an analysis objective; and a second determining subunit, configured to: determine a metric identified by the metric identifier obtained by the second receiving subunit as the metric for the target analysis task, and determine an analytic method corresponding to the analysis objective as the analytic method for the target analysis task based on the analysis objective obtained by the second receiving subunit and a predetermined correspondence between an analysis objective and an analytic method.

In some implementations, the initial text expression template is configured as a first structure; and the first structure includes a to-be-filled content identifier corresponding to the common parameter and a to-be-adjusted content identifier corresponding to the feature parameter.

In some implementations, the initial text expression template includes at least one preconfigured narrative structure, the narrative structure includes at least one preconfigured paragraph, the preconfigured paragraph includes at least one preconfigured sentence, and the preconfigured sentence includes at least one preconfigured phrase.

Further, the first parameter value of the feature parameter is used to identify whether a first service phenomenon occurs; and the adjustment unit 54 includes: a first determining subunit, configured to determine whether the first parameter value falls within a predetermined first value range, the first value range identifying that the first service phenomenon does not occur; and a deletion subunit, configured to: when the first determining subunit determines that the first parameter value falls within the predetermined first value range, delete a first narrative structure used to describe the first service phenomenon in the initial text expression template or delete a first paragraph in the first narrative structure.

Further, the first service phenomenon is a data abnormality state.

Further, the first parameter value of the feature parameter is used to identify a target analysis result among a first analysis result or a second analysis result that possibly occurs; and the adjustment unit 54 includes: a second determining subunit, configured to determine whether the first parameter value falls within a predetermined second value range, the second value range identifying that the target analysis result is the first analysis result; and a selection subunit, configured to: when the second determining subunit determines that the first parameter value falls within the predetermined second value range, determine that a first phrase in the initial text expression template includes a first optional word, the first optional word being used to describe the first analysis result.

The selection subunit is further configured to: when the second determining subunit determines that the first parameter value does not fall within the predetermined second value range, determine that a first phrase in the initial text expression template includes a second optional word, the second optional word being used to describe the second analysis result.

Further, the first analysis result is an increase in a metric value from a previous metric value, the second analysis result is a decrease in the metric value from the previous metric value, the first optional word is highest, and the second optional word is lowest.

Further, the initial text expression template includes a first initial sub-template and a plurality of second initial sub-templates that are subsequent to the first initial sub-template; and the adjustment unit 54 includes: a first adjustment subunit, configured to adjust a content of the first initial sub-template based on the first parameter value, to obtain a first dedicated sub-template; a selection subunit, configured to select a to-be-adjusted second initial sub-template from the plurality of second initial sub-templates based on the first dedicated sub-template obtained by the first adjustment subunit; and a second adjustment subunit, configured to adjust a content of the second initial sub-template selected by the selection subunit to obtain a second dedicated sub-template, the first dedicated sub-template and the second dedicated sub-template forming the dedicated text expression template.

In some implementations, the filling unit 55 includes: a searching subunit, configured to search the dedicated text expression template for a location of a parameter identifier corresponding to the second parameter value; and a filling subunit, configured to fill the second parameter value into the location of the parameter identifier found by the searching subunit in the dedicated text expression template, to obtain the text output result of the data analysis result.

According to the apparatus provided in some implementations of the present specification, first, the execution unit 51 determines a metric and an analytic method for a target analysis task, and executes the target analysis task based on the metric and the analytic method, to obtain a data analysis result; then, the extraction unit 52 extracts a first parameter value of a predetermined feature parameter and a second parameter value of a common parameter from the data analysis result based on parameter configuration information; then, the acquisition unit 53 obtains an initial text expression template configured for the analytic method; then, the adjustment unit 54 adjusts a content of the initial text expression template based on the first parameter value, to obtain a dedicated text expression template; and finally, the filling unit 55 fills the dedicated text expression template based on the second parameter value, to obtain a text output result of the data analysis result. It can be learned from the above that in some implementations of the present specification, the initial text expression template is configured for the analytic method. The initial text expression template can reflect a characteristic of the analytic method, and the initial text expression template is not fixed, and can be adjusted based on the parameter value of the feature parameter in the data analysis result, to obtain the dedicated text expression template. Then, the dedicated text expression template is filled based on the parameter value of the common parameter in the data analysis result, to obtain the text output result. The parameter value of the feature parameter reflects a characteristic of an analysis scenario. As such, adaptability to diversity of analysis scenarios can be implemented, and flexibility and accuracy of text output can be ensured.

According to some implementations of another aspect, a computer-readable storage medium is further provided. The computer-readable storage medium stores a computer program, and when the computer program is executed in a computer, the computer is enabled to perform the method described with reference to FIG. 2.

According to some implementations of still another aspect, a computing device is further provided, including a memory and a processor. The memory stores executable code, and when the processor executes the executable code, the method described with reference to FIG. 2 is implemented.

A person skilled in the art should be aware that in the above one or more examples, the functions described in the present specification can be implemented by hardware, software, firmware, or any combination thereof. When software is used for implementation, these functions can be stored in a computer-readable medium or transmitted as one or more instructions or code in a computer-readable medium.

The objectives, technical solutions, and beneficial effects of the present specification are further described in detail in the above specific implementations. It should be understood that the above descriptions are merely specific implementations of the present specification, but are not intended to limit the protection scope of the present specification. Any modification, equivalent replacement, improvement, etc. made based on the technical solutions of the present specification shall fall within the protection scope of the present specification.

What is claimed is:

1. A text output method in data analysis, the method comprising:
determining a metric and an analytic method for a target analysis task, and executing the target analysis task based on the metric and the analytic method, to obtain a data analysis result;
extracting a first parameter value of a determined feature parameter and a second parameter value of a common parameter from the data analysis result based on parameter configuration information;
obtaining a first text expression template configured for the analytic method;
adjusting a content of the first text expression template based on the first parameter value, to obtain a second text expression template; and
filling the second text expression template based on the second parameter value, to obtain a text output result of the data analysis result.

2. The method according to claim 1, wherein the determining the metric and the analytic method for the target analysis task includes:
receiving an instruction that triggers the target analysis task, the instruction including a metric identifier and a method identifier; and
determining the metric based on the metric identifier, and determining the analytic method based on the method identifier.

3. The method according to claim 1, wherein the determining the metric and the analytic method for the target analysis task includes:
receiving an instruction that triggers the target analysis task, the instruction including a metric identifier and an analysis objective; and
determining the metric based on the metric identifier, and determining an analytic method corresponding to the analysis objective as the analytic method for the target analysis task based on a determined correspondence between an analysis objective and an analytic method.

4. The method according to claim 1, wherein the first text expression template is configured as a first structure; and the first structure includes a to-be-filled content identifier corresponding to the common parameter and a to-be-adjusted content identifier corresponding to the feature parameter.

5. The method according to claim 1, wherein the first text expression template includes at least one narrative structure, the at least one narrative structure each includes at least one paragraph, the at least one paragraph each includes at least one sentence, and the at least one sentence each includes at least one phrase.

6. The method according to claim 5, wherein the first parameter value of the determined feature parameter is configured to identify whether a first service phenomenon occurs; and the adjusting the content of the first text expression template includes:
determining whether the first parameter value falls within a first value range, the first value range identifying that the first service phenomenon does not occur; and
in response to determining that the first parameter value falls within the first value range, deleting a first narrative structure configured to describe the first service phenomenon in the first text expression template or deleting a first paragraph in the first narrative structure.

7. The method according to claim 6, wherein the first service phenomenon is a data abnormality state.

8. The method according to claim 5, wherein the first parameter value of the determined feature parameter is configured to identify a target analysis result among a first analysis result or a second analysis result; and
the adjusting the content of the first text expression template includes:
determining whether the first parameter value falls within a second value range, the second value range configured to identify that the target analysis result is the first analysis result; and
in response to determining that the first parameter value falls within the second value range, adjusting a first phrase in the first text expression template to include a first word, the first word being configured to describe the first analysis result; and
in response to determining that the first parameter value does not fall within the second value range, adjust the first phrase in the first text expression template to include a second word, the second word being configured to describe the second analysis result.

9. The method according to claim 5, wherein the first text expression template includes a first initial sub-template and a plurality of second initial sub-templates that are subsequent to the first initial sub-template; and the adjusting the content of the initial text expression template includes:
adjusting a content of the first initial sub-template based on the first parameter value, to obtain a first adjusted sub-template;
selecting a target second initial sub-template from the plurality of second initial sub-templates based on the first adjusted sub-template; and
adjusting a content of the target second initial sub-template to obtain a second adjusted sub-template, the first adjusted sub-template and the second adjusted sub-template forming the second text expression template.

10. The method according to claim 1, wherein the filling the second text expression template includes:
searching the second text expression template for a location of a parameter identifier corresponding to the second parameter value; and
filling the second parameter value into the location of the parameter identifier in the second text expression template, to obtain the text output result of the data analysis result.

11. A computer-readable storage medium, wherein the computer-readable storage medium stores a computer program, and when the computer program is executed on one or more processors, the one or more processors are enabled to, individually or collectively, perform acts comprising:
determining a metric and an analytic method for a target analysis task, and executing the target analysis task based on the metric and the analytic method, to obtain a data analysis result;
extracting a first parameter value of a determined feature parameter and a second parameter value of a common parameter from the data analysis result based on parameter configuration information;
obtaining a first text expression template configured for the analytic method;
adjusting a content of the first text expression template based on the first parameter value, to obtain a second text expression template; and
filling the second text expression template based on the second parameter value, to obtain a text output result of the data analysis result.

12. The computer-readable storage medium according to claim 11, wherein the determining the metric and the analytic method for the target analysis task includes:
receiving an instruction that triggers the target analysis task, the instruction including a metric identifier and a method identifier; and
determining the metric based on the metric identifier, and determining the analytic method based on the method identifier.

13. The computer-readable storage medium according to claim 11, wherein the determining the metric and the analytic method for the target analysis task includes:
receiving an instruction that triggers the target analysis task, the instruction including a metric identifier and an analysis objective; and
determining the metric based on the metric identifier, and determining an analytic method corresponding to the analysis objective as the analytic method for the target analysis task based on a determined correspondence between an analysis objective and an analytic method.

14. The computer-readable storage medium according to claim 11, wherein the first text expression template is configured as a first structure; and the first structure includes a to-be-filled content identifier corresponding to the common parameter and a to-be-adjusted content identifier corresponding to the feature parameter.

15. A computing device, comprising one or more memory devices and one or more processors, wherein the one or more memory devices, individually or collectively, store computer executable instructions, and when the computer executable instructions are executed by the one or more processors, the one or more processors are enable to, individually or collectively, implement acts including:
determining a metric and an analytic method for a target analysis task, and executing the target analysis task based on the metric and the analytic method, to obtain a data analysis result;
extracting a first parameter value of a determined feature parameter and a second parameter value of a common parameter from the data analysis result based on parameter configuration information;
obtaining a first text expression template configured for the analytic method;
adjusting a content of the first text expression template based on the first parameter value, to obtain a second text expression template; and
filling the second text expression template based on the second parameter value, to obtain a text output result of the data analysis result.

16. The computing device according to claim 15, wherein the first text expression template includes at least one narrative structure, the at least one narrative structure each includes at least one paragraph, the at least one paragraph each includes at least one sentence, and the at least one sentence each includes at least one phrase.

17. The computing device according to claim 16, wherein the first parameter value of the determined feature parameter is configured to identify whether a first service phenomenon occurs; and the adjusting the content of the first text expression template includes:
determining whether the first parameter value falls within a first value range, the first value range identifying that the first service phenomenon does not occur; and
in response to determining that the first parameter value falls within the first value range, deleting a first narrative structure configured to describe the first service phenomenon in the first text expression template or deleting a first paragraph in the first narrative structure.

18. The computing device according to claim 16, wherein the first parameter value of the determined feature parameter is configured to identify a target analysis result among a first analysis result or a second analysis result; and
the adjusting the content of the first text expression template includes:
determining whether the first parameter value falls within a second value range, the second value range configured to identify that the target analysis result is the first analysis result; and
in response to determining that the first parameter value falls within the second value range, adjusting a first phrase in the first text expression template to include a first word, the first word being configured to describe the first analysis result; and
in response to determining that the first parameter value does not fall within the second value range, adjust the first phrase in the first text expression template to include a second word, the second word being configured to describe the second analysis result.

19. The computing device according to claim 16, wherein the first text expression template includes a first initial sub-template and a plurality of second initial sub-templates that are subsequent to the first initial sub-template; and the adjusting the content of the initial text expression template includes:
adjusting a content of the first initial sub-template based on the first parameter value, to obtain a first adjusted sub-template;
selecting a target second initial sub-template from the plurality of second initial sub-templates based on the first adjusted sub-template; and
adjusting a content of the target second initial sub-template to obtain a second adjusted sub-template, the first adjusted sub-template and the second adjusted sub-template forming the second text expression template.

20. The computing device according to claim 15, wherein the filling the second text expression template includes:
searching the second text expression template for a location of a parameter identifier corresponding to the second parameter value; and
filling the second parameter value into the location of the parameter identifier in the second text expression template, to obtain the text output result of the data analysis result.
